(19) United States
(12) Patent Application Publication
(10) Pub. No.: US 2017/0023935 A1
(43) Pub. Date: Jan. 26, 2017

(54) Method and Control System

(71) Applicant: Siemens Aktiengesellschaft, Muenchen (DE)

(72) Inventors: Michael Armbruster, Muenchen (DE); Kai Hoefig, Muenchen (DE)

(73) Assignee: Siemens Aktiengesellschaft, Muenchen (DE)

(21) Appl. No.: 15/303,050

(22) PCT Filed: Feb. 25, 2015
(86) PCT No.: PCT/EP2015/053914

§ 371 Date: Oct. 10, 2016

(30) Foreign Application Priority Data
Apr. 8, 2014 (DE) 10 2014 206 786.3

(51) Int. Cl. G05B 23/02; G05B 19/042

(52) U.S. Cl. CPC G05B 23/0248; G05B 19/042; G05B 2219/40226

(57) ABSTRACT

A method is provided for starting up a function implemented in distributed manner on a number of computation devices in a control system having at least two computation devices coupled via a data communication connection. Output parameters are provided for a number of output variables of the respective computation device, wherein the output variables form function variables for the function. For each input variable of one of the computation devices that has an associated output variable from one of the further computation devices, the output parameters of the output variables are checked for correspondence with prescribed input parameters of the respective input variables. The function is started-up if the output parameters of the output variables correspond to the prescribed input parameters of the respective input variables.

### CROSS-REFERENCE TO RELATED APPLICATIONS

This application is a U.S. National Stage Application of International Application No. PCT/EP2015/053914 filed Feb. 25, 2015, which designates the United States of America, and claims priority to DE Application No. 10 2014 206 786.3 filed Apr. 8, 2014, the contents of which are hereby incorporated by reference in their entirety.

### TECHNICAL FIELD

The present invention relates to a method for starting up a function implemented in a distributed manner in a number of computing devices in a control system having at least two computing devices coupled by means of a data communication connection. In addition, the present invention relates to a corresponding control system.

### BACKGROUND

The present invention is presented below mainly with respect to the starting up of functions in a motor vehicle. In this context, the present invention is, however, not restricted to the field of motor vehicles but rather can be used in any system in which functions are carried out in a distributed manner. This may be the case, for example, in automation systems.

In modern motor vehicles, a large number of distributed functions assist the driver in controlling the vehicle.

In this context, those functions which are implemented by interaction between networked control devices and/or sensors are referred to as distributed functions.

For example, a function for autonomously controlling the vehicle can be implemented as such a distributed function. In the case of such a function, e.g. a plurality of sensors can each supply an image of the surroundings of the vehicle. A control device for performing sensor fusion can receive e.g. object lists and assignment grids from the individual sensors and fuse them to form a global assignment grid and a global object list and in the process perform e.g. plausibility checking of the individual sensor data items.

A control apparatus of an electronic steering system can calculate a course for the vehicle, e.g. based on the global assignment grid, and steer the vehicle on this course.

With such a distributed function, a multiplicity of further control apparatuses can also be involved.

Requirements with respect to the availability and susceptibility to faults of the respective function have to be taken into account during the development of such vehicle functions.

During the development of such functions, what are referred to as FTAs and FMEAs are therefore carried out, in which potential problems of the systems or functions are identified and the probabilities of occurrence thereof are calculated. These are described, e.g., in the generic standard IEC61508 (The International Electrotechnical Commission (IEC): International Standard IEC 61508, Functional safety of electrical/electronic/programmable electronic safety-related systems, 2nd Edition, 2010) and in the standard ISO26262 (The International Organization for Standardization ISO), International Standard ISO26262, Road vehicles—Functional safety—Part 1 to 10, 2012) which is specific to the field of motor vehicle technology.

During the development of such a function, individual components of the system which carries out the function can be adapted if it becomes apparent that the corresponding requirements are not satisfied.

However, when a vehicle or a vehicle system is updated with a new function, e.g. by means of a software update or the downloading of an “App” by the vehicle driver, such checking cannot be carried out. Consequently new functions can only be retrofitted in a restrictive manner in already existing vehicle systems.

### SUMMARY

One embodiment provides a method for starting up a function implemented in a distributed manner in a number of computing devices in a control system having at least two computing devices coupled by means of a data communication connection, comprising: making available output parameters for a number of output variables of the respective computing device, wherein the output variables form functional variables of the function; checking for each input variable of one of the computing devices which is assigned an output variable of one of the further computing devices whether the output parameters of the output variables correspond to predefined input parameters of the respective input variables; and starting up the function if the output parameters of the output variables correspond to the predefined input parameters of the respective input variables.

In one embodiment, the output parameters specify quality criteria, in particular an accuracy level and/or a failure probability level for the individual output variables; and/or the input parameters predefine at least necessary quality criteria for the output variables which are assigned to the respective input variables.

In one embodiment, the output parameters and/or the input parameters of each of the computing devices are each made available in one component model; wherein each component model has: inputs and/or outputs of the respective computing device; and/or an evaluation model of the respective computing device which characterizes the output variables and/or input variables which are required to carry out the function in the computing device; and/or a specific fault model which characterizes possible faults of the respective output variables and/or input variables; and/or a general fault model which characterizes faults of an input and/or an output of the respective computing device.

In one embodiment, the method includes coupling the output variables and/or input variables, specified in the evaluation model, to the corresponding faults specified in the specific fault model; and coupling the faults, specified in the specific fault model, to the corresponding inputs and/or outputs specified in the general fault model.

In one embodiment, during the checking based on the individual component models for all the input variables and output variables as to which are function variables of the function, a hierarchical complete model is formed, and in the hierarchical complete model it is checked whether the output parameters of the corresponding output variables correspond to the predefined input parameters of the respective input variables for all the function variables in the entire hierarchy of the hierarchical complete model.

In one embodiment, each computing device has a uniquely defined identifier; and/or the component models are stored in a central model memory.

In one embodiment, during the checking each of the computing devices transfers the uniquely defined identifier to the central model memory, and the central model memory performs the checking.

In one embodiment, the computing devices are designed to call the component model corresponding to the respective computing device from the model memory; or each computing device stores the component model corresponding to the respective computing device in an internal model memory.

In one embodiment, each of the computing devices is designed to evaluate a partial model, corresponding thereto, of the hierarchical complete model.

In one embodiment, the component models are embodied as reduced component models which only have the general fault model, wherein the data of the evaluation model and/or of the specific fault model are integrated into the general fault model of the reduced component model.

Another embodiment provides a control system having at least one function, in particular for a vehicle, having: at least two computing devices which are coupled to one another by means of a data communication connection; wherein each of the computing devices is designed to make available output variables as function variables of the function, and to receive input variables as function variables of further computing devices of the computing devices; and wherein the computing devices are designed to check, for each input variable to which an output variable of one of the further computing devices is assigned, whether predefined output parameters of the corresponding output variable correspond to predefined input parameters of the respective input variable; and wherein the computing devices are designed to start up the function if the output parameters of the output variables correspond to the predefined input parameters of the respective input variable.

In one embodiment, the output parameters and/or the input parameters of each of the computing devices are each made available in a component model; wherein each component model has: inputs and/or outputs of the respective computing device; and/or an evaluation model of the respective computing device which characterizes the output variables and/or input variables which are required to carry out the function in the computing device; and/or a specific fault model which characterizes possible faults of the respective output variables and/or input variables; and/or a general fault model which characterizes faults of an input and/or of an output of the respective computing device.

In one embodiment, each computing device has a model memory which is designed to store the respective component model; or the control system has a central model memory which is designed to store the component models.

### BRIEF DESCRIPTION OF THE DRAWINGS

Example aspects and embodiment of the present invention explained in more detail below with reference to the figures, in which:

FIG. 1 shows a flowchart of an exemplary embodiment of the method according to the invention;

FIG. 2 shows a block diagram of an embodiment of a control system according to the invention;

FIG. 3 shows an embodiment of a meta model explaining an embodiment of a method according to the invention;

FIG. 4 shows a block circuit diagram of a further embodiment of a control system according to the invention;

FIG. 5 shows an illustration of an embodiment of an evaluation model according to the invention; and

FIG. 6 shows a block diagram of an embodiment of a vehicle architecture.

### DETAILED DESCRIPTION

Embodiments of the present invention provided improved computer control systems, e.g., for starting up a function implemented in a distributed manner in a number of computing devices

Some embodiments provide a method for starting up a function implemented in a distributed manner on a number of computing devices in a control system having at least two computing devices coupled by means of a data communication connection, comprising making available output parameters for a number of output variables of the respective computing device, wherein the output variables form functional variables of the function, checking for each input variable of one of the computing devices which is assigned an output variable of one of the further computing devices whether the output parameters of the output variables correspond to predefined input parameters of the respective input variables, and starting up the function if the output parameters of the output variables correspond to the predefined input parameters of the respective input variables.

Other embodiments provide a control system having at least one function, e.g., for a vehicle, having at least two computing devices which are coupled to one another by means of a data communication connection, wherein each of the computing devices is designed to make available output variables as function variables of the function, and to receive input variables as function variables of further computing devices of the computing devices, and wherein the computing devices are designed to check, for each input variable to which an output variable of one of the further computing devices is assigned, whether predefined output parameters of the corresponding output variable correspond to predefined input parameters of the respective input variable, and wherein the computing devices are designed to start up the function if the output parameters of the output variables correspond to the predefined input parameters of the respective input variable.

The realization on which certain embodiments of the invention is based is that checking of the requirements of individual function variables which are required to execute a function does not necessarily have to take place in a theoretical consideration parallel to the development of the respective function.

A concept on which particular embodiment of the present invention are based is to allow for this realization and to provide a method in which the quality of the output variables of computing devices are specified in the form of output parameters, and the requirements with respect to input variables are specified in the form of input parameters.

If a new function is then implemented in the control system, e.g. by means of a software download, or an already existing function is updated, it can be checked automatically for each computing device whether the output variables of other computing devices meet the requirements made of the input variables of the respective computing device.

If correspondence is detected between the input parameters and the corresponding output parameters, the respective function can be started up.

As a result, embodiments of the present invention may permit subsequent function expansion in control systems in which the control system itself can check whether the requirements for the execution of the respective function are met.

For example, in a control system for a vehicle, a function for autonomous control of the vehicle can be retrofitted as a software module. Before this function is started up, the control system of the vehicle can check automatically whether the individual computing devices in the vehicle meet the precondition for the autonomous control of the vehicle, in particular in terms of the signal quality and availability. Only if this is the case will the function actually be enabled. If this is not the case, the execution of the function is prevented, even if theoretically all the necessary sensors and actuators were available in the vehicle.

In one embodiment, the output parameters specify quality criteria, in particular an accuracy level and/or a failure probability level, for the individual output variables. This makes it possible to evaluate automatically whether the individual variables which are made available by the computing devices are sufficiently precise or reliable to carry out a predefined function. For example, a minimum level of accuracy for a function variable can be predefined for a function, which level of accuracy has to be satisfied if the function is to be able to be carried out satisfactorily.

In one embodiment, the input parameters predefine at least necessary quality criteria for the output variables which are assigned to the respective input variables. If there is a predefinition of which quality criteria each input variable which can serve as a function variable of the function has to satisfy, by means of simple comparison of the input parameters with the corresponding output parameters it is possible to determine whether the requirements of the function are satisfied.

In one embodiment, the output parameters and/or the input parameters of each of the computing devices are each made available in one component model. The component model can represent e.g. the sub-function of the function which is carried out in the respective computing device. As a result, when e.g. a new computing device is added, the corresponding component model can be made available without e.g. a complete model of the control system having to be changed or adapted.

In one embodiment, each component model has inputs and/or outputs of the respective computing device and/or an evaluation model of the respective computing device which characterizes the output variables and/or input variables which are required to carry out the function in the computing device, and/or a specific fault model which characterizes possible faults of the respective output variables and/or input variables, and/or a general fault model which characterizes faults of an input and/or an output of the respective computing device. In this context, the model can be present in different refinements. For example, the evaluation model of the respective computing device can be a qualitative or quantitative model which can be used to evaluate the quality of the respective component. For example, the evaluation model can be a fault-tree analysis model (FTA model) or a failure mode and effect analysis model (PMEA model). In such a qualitative or quantitative model, the input variables and output variables which serve as function variables in the respective computing device are characterized or evaluated. In this context, the individual variables can be assigned e.g. what is referred to as a safety integrity level, also an SIL level or in the automotive field an automotive SIL level, which specifies the requirements of the respective variable. In particular, the evaluations of the output variables of a computing device can be calculated based on the input variables which are necessary to form the respective output variable. This specific fault model characterizes here possible faults of the specific output variables and/or input variables of the respective computing device. For example, in the case of a radar sensor the fault can be specified in the specific fault model for the radar antenna in such a way that despite a received signal said antenna does not output a signal. This may be the case e.g. owing to an interrupted signal line. In one embodiment, the general fault model can characterize e.g. a general fault of an input signal and/or of an output signal, such as e.g. an input signal does not supply any values or an input signal supplies excessively high or excessively low values, of the respective computing device.

In one embodiment, the method comprises coupling the output variables and/or input variables, specified in the evaluation model, to the corresponding faults specified in the specific fault model. In addition, the method comprises coupling the faults, specified in the specific fault model, to the corresponding faults of the inputs and/or outputs specified in the general fault model. This may occur, e.g., at the design time of the function. As a result, the signal paths and the resulting possible faults of a function can be identified. In addition, later during the starting up of the function in a control system the corresponding signal paths can be automatically detected and automatically evaluated in the specific computing devices.

In one embodiment, during the checking based on the individual component models for all the input variables and output variables as to which are function variables of the function, a hierarchical complete model is formed, and in the hierarchical complete model it is checked whether the output parameters of the corresponding output variables correspond to the predefined input parameters of the respective input variables for all the function variables in the entire hierarchy of the hierarchical complete model. As already mentioned above, the output parameters of the output variables of a computing device can be calculated as a function of the respective evaluation model and of the corresponding input variables of the respective computing device. In this way, the entire signal path of a function variable of the function can be checked in the hierarchical complete model. In this context, without previous knowledge of the individual computing devices and of the output parameters of the respective output variables it is possible to evaluate functions automatically in the respective control system before the starting up.

In one embodiment, each computing device has a uniquely defined identifier. This permits the simple assignment of a component model to a computing device.

In one embodiment, the component models are stored in a central model memory. This permits central administration and handling of the component models. In addition, there is no need to make available any storage for the component models in the individual computing devices.

In one embodiment, during the checking of each of the computing devices, the uniquely defined identifier is transferred to the central model memory, and the central model memory performs the checking. This permits very efficient calculation of the hierarchical complete model and therefore very efficient evaluation of the control system with respect to a specific function.

In one embodiment, the computing devices are designed to call the component model corresponding to the respective computing device from the model memory. In one embodiment, each computing device stores the component model corresponding to the respective computing device in an internal model memory. This permits evaluation of a control system to be performed with respect to a function without a connection to the central data memory. In such an embodiment it is possible, e.g., for a computing device to call the individual component models from all the computing devices and perform the necessary calculations.

In one embodiment, each of the computing devices is designed to evaluate a partial model, corresponding thereto, of the hierarchical complete model. As a result, the necessary calculations can be carried out in parallel and the computing power which is required in the individual computing devices is reduced.

In one embodiment, the component models are embodied as reduced component models which only have the general fault model, wherein the data of the evaluation model and/or of the specific fault model are integrated into the general fault model of the reduced component model. This reduces the computational outlay and the memory requirement compared to the storage of the entire component model in the individual computing devices.

The above embodiments and developments can be combined with one another, insofar as appropriate. Further possible embodiments, developments and implementations of the invention comprise combinations, also not explicitly mentioned, of features of the invention which have been described above or below with respect to the exemplary embodiments. In particular, in this context a person skilled in the art will also add individual aspects as improvements or additions to the respective basic form of the present invention. based on

A function which is implemented in a distributed manner is understood to be a function which is executed on a plurality of computing devices or for whose execution function variables from a plurality of computing devices are used. For example, a function which is implemented in a distributed manner can be a function in a vehicle which controls the vehicle autonomously. For this purpose data can be used from intelligent sensors such as e.g. radar sensors, cameras, movement sensors and acceleration sensors or the like. In particular, data which has already been conditioned such as e.g. an assignment grid of the surroundings of the vehicle, an object list or the like, can be made available by the sensors as function variables which are evaluated jointly by a further control apparatus of the vehicle in order to actuate actuators in the vehicle. Input variables and output variables denote, within the scope of this patent application, variables which are output by the individual computing devices or received and evaluated thereby. Since computing devices can have a multiplicity of input variables and output variables, only those input variables and output variables which are necessary to carry out the respective function are denoted as function variables.

The input parameters and output parameters prescribe, for the respective input variables and output variables, corresponding requirements which the input variables and output variables must meet in order to be able to carry out the function reliably. In this context the input parameters and output parameters can specify inter alia fault probabilities, accuracy levels or the like of the input variables and output variables. The input parameters and output parameters can also specify standardized evaluations of the signals such as e.g. SIL levels according to IC 61508 or ASIL levels according to ISO 26262.

A computing device is to be understood as any device which can carry out data acquisition, data processing and/or actuation of actuators.

A qualitative or quantitative model is to be understood within the scope of this patent application as a model which permits the function to be evaluated or all the function variables which are necessary for the function to be evaluated. For example, such a model can be an FTA model, fault-tree analysis model or an FMEA, failure mode and effect analysis model. These models may be stored e.g. as XML-based model descriptions, with any other suitable model description being also possible.

In the FMEA method for considering the quality of electrical systems, what is referred to as a “forward logic” is applied. For this purpose, the potential faults of individual elements are taken as starting point and their effects on the complete system are examined.

FTA pursues the reverse approach. Starting with a possible fault of the system there is examination of which individual faults or faults chains can lead to this fault.

Based on the FMEA or FTA analyses, the corresponding input parameters or output parameters can be determined e.g. for all the computing devices or the input variables and output variables of a computing device which form function variables of the function.

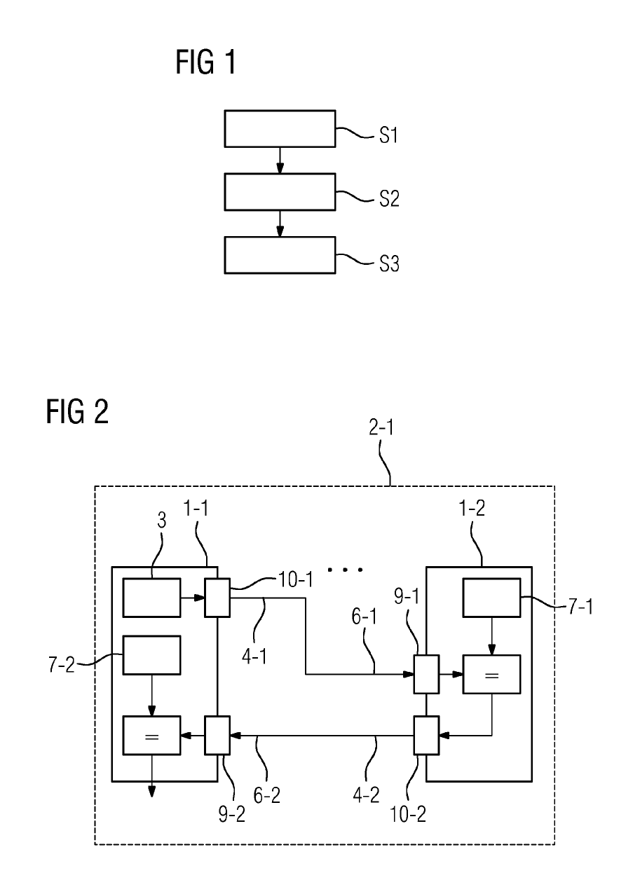

FIG. 1 shows a flowchart of an embodiment of the method according to the invention for setting up a function 5-1-5-n, implemented in a distributed manner on a number of computing devices 1-1-1-11, in a control system 2-1-2-3 having at least two computing devices 1-1-1-11 which are coupled by means of a data-communication connection. A function 5-1-5-n which is implemented in a distributed manner is to be understood here as meaning that the function is calculated on at least two computing devices 1-1-1-11. The computing devices 1-1-1-11 can, for this purpose, communicate with one another e.g. via a data bus and make available to one another function variables or output variables 4-1-4-4 which are necessary for calculating the function 5-1-5-n. In this context, the output variables 4-1-4-4 are each assigned to input variables 6-1-6-4 of the receiving computing device 1-1-1-11.

The method provides for output parameters 3 to be made available for a number, that is to say for one or more, of the output variables 4-1-4-4 of each of the computing devices 1-1-1-11 which are at the same time function variables of the function 5-1-5-n. For other output variables which are not function variables of the function 5-1-5-n, this is not necessary but possible. If the output parameters 3 are made available for all the output variables of a computing device 1-1-1-11, they can be used in later expansions of the function or in new functions.

Therefore, in the same way as the output parameters 3 are made available, input parameters 7-1-7-2 are also made available for the input variables 6-1-6-4. The output parameters 3 characterize here certain parameters or requirements which the respective output variable meets. In contrast, the input parameters 7-1-7-2 characterize those parameters or requirements which an output variable 4-1-4-4 of a computing device 1-1-1-11 must meet, which output variable is intended to serve as an input variable 6-1-6-4 of another computing device 1-1-1-11.

The method also performs checking, S2, of the input parameters 7-1-7-2 and of the corresponding output parameters 3 for each of the input variables 6-1-6-4. This can be done e.g. by means of simple comparison. If the output parameters 3 of the output variables 4-1-4-4 meet the input parameters 7-1-7-2 of the respective input variables 6-1-6-4, the function 5-1-5-n can be started up, S3.

The input parameters 7-1-7-2 and output parameters 3 can have e.g. an accuracy level, a failure probability, a temperature stability level and a long-term stability level, a latency and the like.

The evaluation of a function 5-1-5-n or of the input variables 6-1-6-4 and output variables 4-1-4-4 which are required for it is to be carried out during the running time of the control system 2-1-2-3. For this purpose, in one embodiment, a component model 8-1-8-4 can be made available for each of the computing devices 1-1-1-11. This permits simple linking of the individual component models 8-1-8-4 to form a complete model by means of which the entire function 5-1-5-n is represented.

The component model 8-1-8-4 can have, in one embodiment, an evaluation model 11-1-11-5 in which the output variables 4-1-4-4 and/or input variables 6-1-6-4 which are required to carry out the function 5-1-5-n in the computing device 1-1-1-11 are characterized. Characterized is to be understood here as meaning that a qualitative or quantitative evaluation of the output variables 4-1-4-4 and/or input variables 6-1-6-4 takes place. This can take place e.g. based on an FTA analysis or an FMEA analysis or the like. The evaluation model can also have variables, such as e.g. measured values, generated by the respective computing device 1-1-1-11 itself. From an FTA analysis it is possible to derive e.g. which specific elements of a computing device 1-1-1-11 can be involved in the occurrence of a specific fault. In this context, e.g. possible faults can be specified for each of the output variables 4-1-4-4 and/or input variables 6-1-6-4 and a corresponding probability level specified for them.

The component model 8-1-8-4 can in one embodiment also have a specific fault model 12-1-12-4 which assigns possible faults of the respective specific elements of a computing device 1-1-1-11 to the faults of the output variables 4-1-4-4 and/or input variables 6-1-6-4. For example, a specific fault of an ultrasonic sensor from the evaluation model 11-1-11-5 can be assigned to a specific fault of a distance sensor in the specific fault model 12-1-12-4.

In one embodiment it is also possible to provide a general fault model 13-1-13-4 which characterizes faults of an input and/or of an output of the respective computing device 1-1-1-11. For example, the specific fault of a distance sensor in the specific fault model 12-1-12-4 can be assigned to a general fault which characterizes incorrect output data. In one embodiment, logic linking operations of the inputs 9-1-9-5 and/or outputs 10-1-10-5 of the respective computing device 1-1-1-11 which are necessary for a corresponding function 5-1-5-n are stored.

It is therefore possible, for a function 5-1-5-n, to generate based on the individual component models 8-1-8-4 a hierarchical complete model of the function 5-1-5-n, and the entire signal paths can be calculated automatically over all the computing devices 1-1-1-11.

In one embodiment, the individual component models 8-1-8-4 can be stored here in the individual computing devices 1-1-1-11. Additionally or alternatively, the individual component models 8-1-8-4 can, however, also be stored in a central model memory 16.

For example, each of the computing devices 1-1-1-11 can be assigned a uniquely defined identifier 15 which can be transferred by the control system 2-1-2-3 in an e.g. wireless manner to the central model memory 16. The central model memory 16 can in response itself carry out the necessary calculations for enabling or setting up the function or can make available the individual component models 8-1-8-4 to the control system 2-1-2-3. The necessary calculations can then be carried out centrally by one of the computing devices 1-1-1-11. Alternatively, each of the computing devices 1-1-1-11 can itself carry out the calculations based on its component model 8-1-8-4 for the purpose of enabling the function.

In one embodiment, the component models 8-1-8-4 are stored in the form of reduced component models 8-1-8-4 in the individual computing devices 1-1-1-11. For this purpose, all the calculations which relate to the evaluation model 11-1-11-5 and the specific fault model 12-1-12-4 can have already been carried out before the storage of the respective component model 8-1-8-4. The multi-layer component model 8-1-8-4 is reduced, as it were, to one layer, the general fault model 13-1-13-4. For this purpose, it is possible to define e.g. common conventions for all the component models 8-1-8-4, with the result that subsequent calculations in the evaluation model 11-1-11-5 and the specific fault model 12-1-12-4 become superfluous. It is possible to predefine, e.g., that failure probabilities are specified as 8-bit integer values with a numeral range from 0-255.

FIG. 2 shows a block circuit diagram of an embodiment of a control system 2-1 according to the invention.

The control system 2-1 carries out at least one function 5-1-5-n which is carried out distributed between the two computing devices 1-1 and 1-2. Further computing devices are indicated by three points. For this purpose, it is possible to couple the latter to one another, e.g., via a data bus, such as e.g. a CAN bus, a FlexRay bus or the like.

Each of the computing devices 1-1 and 1-2 is designed to output variables 4-1, 4-2 which are function variables of the function 5-1-5-n and to receive, from other computing devices 1-1, 1-2, input variables 6-1; 6-2 which are also function variables of the function 5-1-5-n. In FIG. 2, the computing device 1-1 outputs, via the output 10-1, an output variable 4-1 which is received as an input variable 6-1 by the computing device 1-2 via the input 9-1. For the output variable 4-1, the computing device 1-1 makes available the output parameters 3 which characterize the output variable 4-1. These output parameters 3 are compared by the computing device 1-2 with input parameters 7-1 of the input variable 6-1. If the requirements predefined by the input parameters 7-1 are met, the computing device 1-2 can enable its part of the function 5-1-5-5n. The computing device 1-2 itself outputs an output variable 4-2 to the computing device 1-1. For the sake of clarity, no output parameters are illustrated for the latter. The computing device 1-1 compares said output parameters with the corresponding input parameters 7-2. If the output variable 4-2 meets the requirements, computing device 1-1 can also enable its part of the function 5-1-5-n. If all the computing devices 1-1, 1-2 enable their partial functions of the function 5-1-5-n, the function 5-1-5-n can be carried out in the control system 2-1.

As are already presented with respect to FIG. 1, the output parameters 3 and/or the input parameters 7-1-7-2 can each be made available in a component model 8-1-8-4.

In this context, each computing device 1-1, 1-2 can have a model memory which is designed to store the respective component model 8-1-8-4. In particular, a reduced component model 8-1-8-4 can also be stored in the individual computing devices 1-1, 1-2, as described above.

Alternatively, in the control system 2-1, or externally with respect to the control system, it is possible to provide a central model memory 16 which is designed to store the component models 8-1-8-4.

The linking illustrated in FIG. 2 between the individual outputs 10-1, 10-2 and the inputs 9-1, 9-2 can be defined, in one embodiment, during the development of the function 5-1-5-n. This requires at least that the type of computing devices 1-1, 1-2 is known at the time of the development of the function. E.g. all that needs to be known is that an ultrasonic sensor or a radar sensor is installed in a vehicle. The quality which the ultrasonic sensor or radar sensor has is not relevant at the development time, since this can be performed for starting up or certifying the function in the respective control system 1-1 in accordance with the present invention.

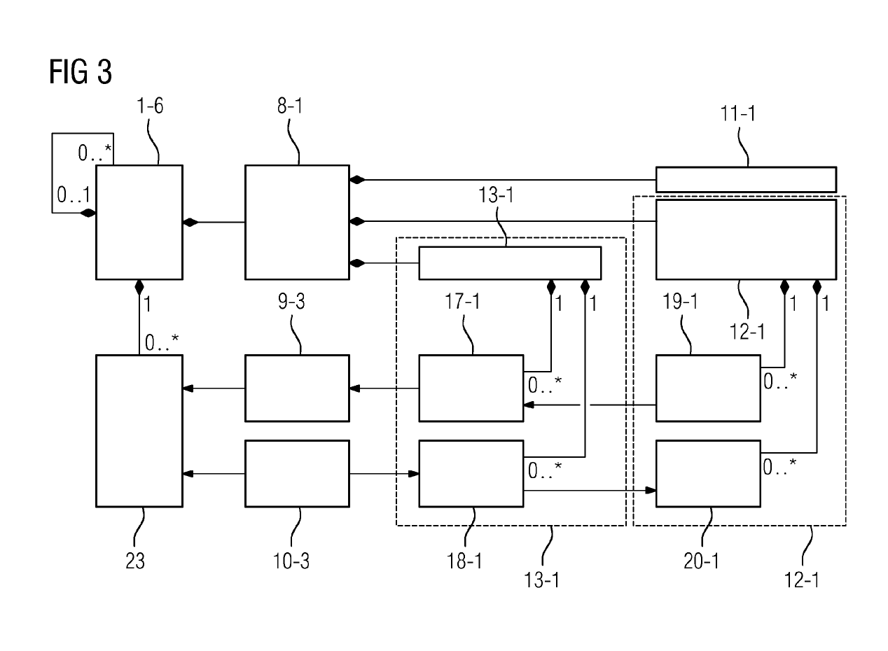

FIG. 3 shows an embodiment of a meta model for explaining an embodiment of a method according to the invention. In this context, the method can be used e.g. for quality certification at the starting-up time. The certification therefore does not take place at the development time.

The meta model in FIG. 3 is embodied as a UML class diagram. Any other type of formation or formulation of the meta model is, however, also possible.

Adaptable control systems 2-1-2-3 are composed, as already stated above, from a multiplicity of independent computing devices 1-1-1-11, also referred to below as components of the control system 2-1-2-3. In this context, the latter can also be composed of a hierarchy of sub-components. The sub-components can have e.g. sensors, processors, inputs and outputs and the like.

Each computing device 1-1-1-11 can have a multiplicity of sub-components (optional), and each sub-component, apart from the computing device 1-1-1-11 arranged at the top level, also top-level component, is associated with precisely one computing device 1-1-1-11. The computing devices 1-1-1-11 can be linked to one another using inputs 10-3 and outputs 9-3, e.g. via connecting block 23.

Each connection block 23 is associated with precisely one computing device 1-1-1-11. Each computing device 1-1-1-11 has precisely one component model 8-1 which can be examined during starting up, e.g. for certification purposes.

The component model 8-1 comprises an evaluation model 11-1 which has a quantitative or qualitative analysis model for the respective computing device 1-1-1-11 or individual parts thereof. Such an evaluation model 11-1 can have e.g. an FTA model or an FMEA model or the like and can be designed, in particular at the development time, to perform analysis, for example of the reliability of the computing device 1-1-1-11. In addition, the component model 8-1 comprises, in one embodiment, two fault categorizing systems or fault models 12-1, 13-1. The specific fault model 12-1 addresses elements or variables of the evaluation model 11-1 which are necessary for certification at the starting-up time. In particular, the specific fault model 12-1 characterizes possible faults or types of fault of the corresponding elements or variables. For this purpose, the specific fault model 12-1 has a section or an input fault model 20-1 which serves to characterize faults of the incoming function variables or input variables 6-1-6-4. In addition, a section or an output fault 19-1 is provided which serves to characterize faults of the outgoing function variables or output variables 4-1-4-4.

The component model 8-1 also comprises a general fault model 13-1. This serves to characterize the connections between different computing devices 1-1-1-11 and to characterize possible faults of the corresponding elements or variables. The general fault model 13-1 also has an input fault model 18-1 and an output fault model 17-1. The input fault model 18-1 characterizes faulty or disrupted data or faults or types of fault of the respective data which are made available to the respective computing device 1-1-1-11 by one of the other computing devices 1-1-1-11, e.g. via the connecting block 23.

In particular, at the development time it is possible for the types of fault of the input fault model 18-1 which make available the information about incoming faulty or disrupted data of one of the other computing devices 1-1-1-11 to be linked to the corresponding types of fault of the input fault model 20-1 of the specific fault model 12-1.

The output fault model 17-1 characterizes faulty or disrupted data or faults or types of fault of the respective data which are made available by the respective computing device 1-1-1-11 to one of the other computing devices 1-1-1-11, e.g. via the connecting block 23.

The types of fault of the output fault model 17-1 which make available the information about outgoing faulty or disrupted data of the respective computing devices 1-1-1-11 can also be linked here, in particular at the development time, to the corresponding types of fault of the output fault model 19-1 of the specific fault model 12-1.

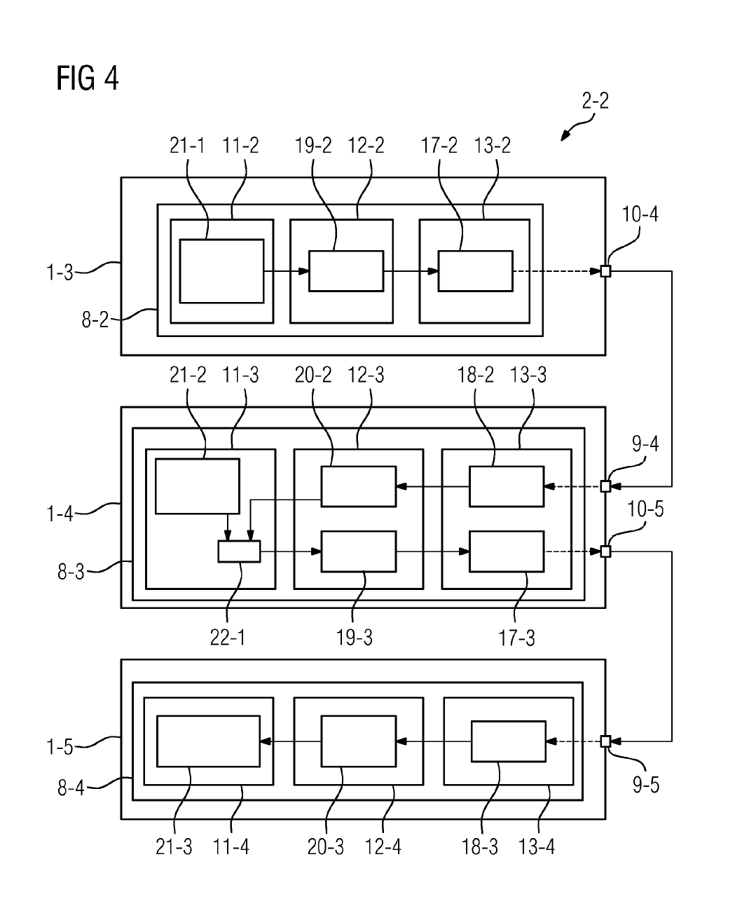

FIG. 4 shows a block circuit diagram of a further embodiment of a control system 2-2 according to the invention.

The control system 2-2 has three computing devices 1-3-1-5.

The computing device 1-3 is a sensor device 1-3, in particular with an ultrasonic sensor for distance measurement. The computing device 1-4 is designed to perform plausibility checking of the data of the computing device 1-3 and to detect faulty data. Finally, the computing device 1-5 is embodied as a controller for a brake actuator, which controller can initiate, based on the data of the ultrasonic sensor, a deceleration of a vehicle, e.g. during an automatic parking process.

FIG. 4 does not illustrate in this context the components of the individual computing devices 1-3-1-5 which are necessary for the normal function thereof. Instead, FIG. 4 illustrates the individual models which have the respective output parameters and input parameters.

The computing device 1-3 has a component model 8-2 with an evaluation model 11-2 which is coupled to a specific fault model 12-2. The specific fault model 12-2 is in turn coupled to a general fault model 13-2.

The evaluation model 11-2 illustrates the fault 21-1 which stands for a fault of the ultrasonic sensor. The probability of this fault can be specified e.g. as an integer value with 8 bit, 16 bit or 32 bit accuracy. The same applies to all other faults.

The fault 21-1 is coupled to the output fault model 19-2 in which a specific distance sensor fault is characterized. Finally, the output fault model 19-2 is coupled to the output fault model 17-2 which characterizes a general data fault. The general data fault stands e.g. for the outputting of data by the computing device 1-3 which do not correspond to reality.

The output 10-4 of the computing device 1-3 is coupled to an input 9-4 of the computing device 1-4. This coupling is understood to be an assignment which characterizes that the variable characterized by the output 10-4, in this case the measured value of the ultrasonic sensor, is detected and processed by the computing device 1-4. In this context it is not necessary, as illustrated in FIG. 4, for a discrete direct coupling to take place between the computing devices 1-3 and 1-4. Instead, the measured values of the ultrasonic sensor can be transmitted to the computing device 1-4 in any desired way, e.g. via a digital data bus.

The computing device 1-4 has an input 9-4 which is coupled to the general fault model 13-3 of the component model 8-3. The general fault model 13-3 is coupled to the specific fault model 12-3 which is coupled to the evaluation model 11-3.

The input 9-4 is coupled here to the input fault model 18-2, which characterizes a general fault of an input variable, the general fault model 13-3. The input fault model 18-2 is coupled to the input fault model 20-2, which characterizes a fault of a specific function variable.

The evaluation model 11-3 illustrates the fault 21-2 which stands for a fault in the qualification of the input data, as a result of which faulty input data are characterized as correct or fault-free. The probability of this fault can also be specified e.g. as an integer value with 8 bits, 16 bits or 32 bits accuracy.

In order to output a faulty value from the computing device 1-4 to the computing device 1-5, both a faulty input variable must be present and the qualification of the faulty input variable must fail. This is illustrated by the AND logic operation 22-1, which also logically links these two conditions to one another. The probability of the outputting of a faulty value by the computing device 1-4 consequently arises from the multiplication of the two probabilities for the faulty qualification and the faulty measured value.

The output of the AND logic operation 22-1 is assigned to an output fault model 19-3 of the specific fault model 12-3, and from there to the output fault model 17-3 of the general fault model 13-2.

Finally, the output of the output fault model 17-3 is assigned to the output 10-5 of the computing device 1-4. The output 10-5 consequently characterizes the fault combination of the faulty measured values of the ultrasonic sensor of the computing device 1-3 and a faulty qualification of the measured values by the computing device 1-4. The probability of the occurrence can be represented in the form of corresponding output parameters.

The output 10-4 is coupled to the input 9-5 of the computing device 1-5 which is coupled to the input fault model 18-3 of the general fault model 13-4. The input fault model 18-3 is coupled to the input fault model 20-3 of the specific fault model 12-4, which is coupled to a fault 21-3 of the evaluation model 11-4.

The fault 21-3 characterizes undesired triggering of a braking process of the vehicle by the computing device 1-5 based on faulty measured values of the ultrasonic sensor of the computing device 1-3 which have not been detected by the computing device 1-4.

In order to certify the function in the control system 2-2, the fault probability can be calculated automatically for the occurrence of the fault 21-3 and compared with a limiting value for the fault probability. If the fault probability for the occurrence of the fault 21-3 exceeds this limiting value, the function is not started up.

FIG. 4 illustrates merely by way of example that a type of fault of an individual sensor is used for certification or enabling. This illustration constitutes a simplification and serves for better understanding. In further embodiments, further variables can therefore be considered which are relevant for the execution of the function.

In particular, according to one embodiment of the method according to the invention all the variables and all the computing devices which are relevant for the execution of the function are considered.

The creation of the abovementioned models of the individual computing devices 1-3-1-5 usually takes place at a development time of the control system 2-2. In one embodiment, the models can, however, be created using, for example, a corresponding database, during the starting up for the certification or qualification. The individual computing devices 1-3-1-5 can, for the starting up, be linked to other computing devices 1-3-1-5 for the implementation, e.g. of the function of a vehicle deceleration during automatic parking, if objects are too close to the vehicle. This linking does not have to include the setting up of new physical connections. Instead, e.g., data which are output by one of the computing devices 1-3-1-5 on a data bus are read in from another computing device 1-3-1-5.

Since the triggering of an undesired braking process is a possible fault situation, see fault 21-3, the computing device 1-5 has information on the maximum permitted residual probability of an undesired braking command. As a result of the coupling, described above, of the individual computing devices 1-3-1-5 to one another, a corresponding fault tree which permits the calculation of this residual probability can be constructed in the control system 2-2.

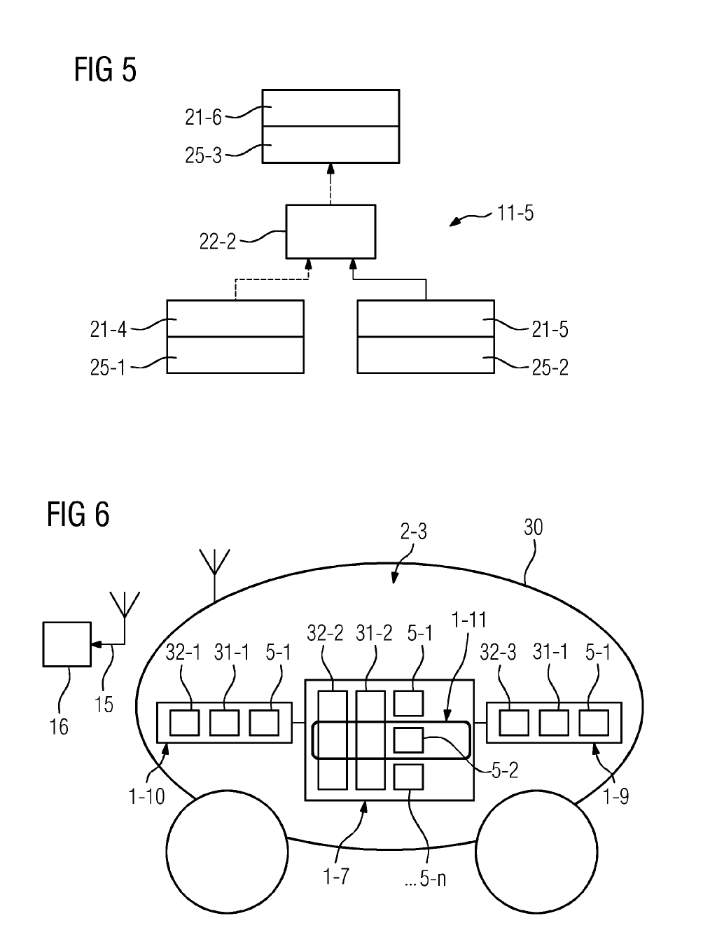

FIG. 5 shows an illustration of an embodiment of an evaluation model 11-5 according to the invention in the form of a fault tree which is obtained for the control system in FIG. 4.

In the fault tree, the fault 21-6, which stands for undesired braking of the vehicle, also referred to as a main event, is characterized by a probability 25-3. The fault 21-6 results here from an AND logic operation linking 22-2 of the two faults 21-4 and 21-5.

In this context, the fault 21-4 stands for a fault of an ultrasonic sensor which occurs with the probability 25-1. The fault 21-5 stands for a fault in the detection or qualification of the faulty sensor data of the ultrasonic sensor.

Since all the input information for the formation of the fault tree is known and is assigned a probability, the resulting probability can be calculated for the main event of the fault tree. This probability can then be compared with a predefined probability value in order to certify the function 5-1-5-n. If the resulting probability, which is determined based on the basic event, faults 21-4 and faults 21-5, is below the required probability value, the system can certify the current combination of functionalities, for example the detection of damaged sensor data and the quality of the sensor data, and the reliable interaction of the components.

Such a certification or starting up can be stored e.g. in a central model memory 16. In particular, such certification can also be carried out in such a central model memory 16 as already illustrated above.

FIG. 6 shows a block circuit diagram of a vehicle 30 with an embodiment of a control system 2-3.

The control system 2-3 has a computing device 1-10 which is coupled to a computing device 1-7, which is in turn coupled to a computing device 1-9. The computing device 1-7 has here a computing device 1-11, which is formed as a “virtual” or logic computing device from those components of the computing device 1-7 which are necessary to execute the function 5-2 of the computing device 1-11.

Each of the computing devices 1-7-1-11 has a memory 32-1-32-3 and a processor 31-1-31-3 which serve to execute a function 5-1-5-n. In this context, the computing devices 1-7, 1-9 and 1-10 together execute the function 5-1. In one embodiment, the function 5-1 can be the execution of a braking process. In this context, the computing device 1-10 can correspond e.g. to the computing device 1-3 in FIG. 4. The computing device 1-7 can correspond to the computing device 1-4 in FIG. 4, and the computing device 1-9 can correspond to the computing device 1-5 in FIG. 4.

Although the present invention has been described above based on preferred embodiments, it is not restricted thereto but rather can be modified in a variety of ways. In particular, the invention can be changed or modified in a variety of ways without departing from the core of the invention.

What is claimed is:

1. A method for starting up a function implemented in a distributed manner in a number of computing devices in a control system having at least two computing devices coupled via a data communication connection, the method comprising:
providing output parameters for a number of output variables of each respective computing device, wherein the output variables form functional variables of the function;
for a respective computing device having at least one input variable having an assigned output variable of another computing devices, checking whether the output parameters of each output variable assigned to a respective input variable correspond to predefined input parameters of the respective input variables; and
starting up the function in response to a determination that the output parameters of the output variables correspond to the predefined input parameters of the respective input variables.

2. The method of claim 1,
wherein the output parameters specify quality criteria, in particular an accuracy level and/or a failure probability level for the individual output variables; and/or
wherein the input parameters predefine at least necessary quality criteria for the output variables which are assigned to the respective input variables.

3. The method of claim 1,
wherein the output parameters and input parameters of each computing device are made available in a respective component model;
wherein the component model of each respective computing device has at least one of:
inputs and/or outputs of the respective computing device; or
an evaluation model of the respective computing device that characterizes output variables and/or input variables that are required to perform the function in the respective computing device; or
a specific fault model that characterizes possible faults of the respective output variables and/or input variables; or
a general fault model that characterizes faults of an input and/or an output of the respective computing device.

4. The method of claim 3, comprising:
coupling the output variables and/or input variables, specified in the evaluation model, to corresponding faults specified in the specific fault model; and
coupling the faults, specified in the specific fault model, to corresponding inputs and/or outputs specified in the general fault model.

5. The method of claim 4, for each respective component models, performing a checking process to identify associated input variables and output variables that are function variables of the function, forming a hierarchical complete model during the checking process, and
checking, in the hierarchical complete model, whether output parameters of corresponding output variables correspond to predefined input parameters of respective input variables for all function variables in a full hierarchy of the hierarchical complete model.

6. The method of claim 3, wherein:
each computing device has a uniquely defined identifier; and
the component models of the computing devices are stored in a central model memory.

7. The method of claim 6, wherein during the checking process, each of the computing devices transfers the uniquely defined identifier to the central model memory, and the central model memory performs the checking process.

8. The method of claim 3,
wherein the computing devices are configured to call the component model corresponding to the respective computing device from the model memory; or
wherein each computing device stores the component model corresponding to the respective computing device in an internal model memory.

9. The method of claim 8, wherein each of the computing devices is configured to evaluate a partial model, corresponding to that computing device, of the hierarchical complete model.

10. The method of claim 8, wherein the component models are embodied as reduced component models including only the general fault model,
wherein data of at least one of the evaluation model or the specific fault model are integrated into the general fault model of the reduced component model.

11. A control system for at least one function of a vehicle, the control system comprising:
at least two computing devices coupled to each another by a data communication connection;
wherein each of the computing devices is configured to provide output variables as function variables of the function, and to receive input variables as function variables of further computing devices of the computing devices; and
wherein the computing devices are configured to check, for each input variable to which an output variable of one of the further computing devices is assigned, whether predefined output parameters of the corresponding output variable correspond to predefined input parameters of the respective input variable; and
wherein the computing devices are configured to start up the function if the output parameters of the output variables correspond to the predefined input parameters of the respective input variable.

12. The control system of claim 11,
wherein the output parameters and/or the input parameters of each of the computing devices are each provided in a component model;
wherein the component model of each respective computing device has at least one of:
inputs and/or outputs of the respective computing device; or
an evaluation model of the respective computing device that characterizes output variables and/or input variables that are required to perform the function in the respective computing device; or
a specific fault model that characterizes possible faults of the respective output variables and/or input variables; or
a general fault model that characterizes faults of an input and/or of an output of the respective computing device.

13. The control system of claim 12,
wherein each computing device has a model memory that stores the respective component model of that computing device; or
wherein the control system has a central model memory that stores the component models of the computing devices.
